(19) United States
(12) Patent Application Publication
(10) Pub. No.: US 2025/0383593 A1
(43) Pub. Date: Dec. 18, 2025

(54) PROJECTION DEVICE AND METHOD OF OPERATING THE SAME

(71) Applicant: SAMSUNG ELECTRONICS CO., LTD., Suwon-si (KR)

(72) Inventors: Donguk KIM, Suwon-si (KR); Sehyun KIM, Suwon-si (KR); Yeonwoo KIM, Suwon-si (KR); Jongin LEE, Suwon-si (KR); Donghwa JEONG, Suwon-si (KR); Minhyo JUNG, Suwon-si (KR)

(73) Assignee: SAMSUNG ELECTRONICS CO., LTD., Suwon-si (KR)

(21) Appl. No.: 19/306,380

(22) Filed: Aug. 21, 2025

Related U.S. Application Data
(63) Continuation of application No. PCT/KR2025/006179, filed on May 8, 2025.

(30) Foreign Application Priority Data
Jun. 17, 2024 (KR) 10-2024-0078475

(51) Int. Cl. G03B 21/14; G03B 21/20; G03B 21/30; G09G 3/00

(52) U.S. Cl. CPC G03B 21/142; G03B 21/208; G03B 21/30; G09G 3/002; G09G 2340/0464; G09G 2354/00

(57) ABSTRACT

A movable projection device includes: a projector including: a first lens having a first focal length, and a second lens having a second focal length greater than the first focal length, where the projector is configured to project image content through a projection lens that is one of the first lens and or the second lens; a lens driver configured to change the projection lens through which the image content is projected; a memory storing instructions; and at least one processor configured to execute the instructions to: identify a position at which the image content is to be projected, based on the position at which the image content is to be projected, identify whether to move the movable projection device and identify whether to change the projection lens, control the lens driver to change the projection lens in a moving state of the movable projection device.

### CROSS-REFERENCE TO RELATED APPLICATION(S)

This application is a continuation of International Application No. PCT/KR2025/006179, filed on May 8, 2025, in the Korean Intellectual Property Receiving Office, which is based on and claims priority to Korean Patent Application No. 10-2024-0078475, filed on Jun. 17, 2024, in the Korean Intellectual Property Office, the disclosures of which are incorporated by reference herein in their entireties.

### BACKGROUND

### 1. Field

The disclosure relates to a projection device for projecting image content and a method of operating the same.

### 2. Description of Related Art

Projection devices are for projecting an image onto a screen or a space. A projection device may include a projector, a device for providing virtual reality (VR), augmented reality (AR), or mixed reality (MR), and the like.

Projection devices are utilized in various fields. For example, they may be used for lectures or presentations in classrooms or conference rooms, or for projecting movies onto screens in movie theaters. Devices for providing VR, AR, or MR may provide, when worn, the experience of watching a movie in a movie theater by displaying an image on a screen (a display) arranged near the user's eyes.

Recently, movable projection devices capable of both near-distance and far-distance projection through a dual-lens configuration have been developed. Using such a projection device may allow for the appropriate projection of various pieces of image content according to the projection environment.

### SUMMARY

Aspects will be set forth in part in the description which follows and, in part, will be apparent from the description, or may be learned by practice of the presented embodiments.

According to an aspect of the disclosure, a movable projection device may include: a projector including: a first lens having a first focal length, and a second lens having a second focal length greater than the first focal length, where the projector is configured to project image content through a projection lens that is one of the first lens and or the second lens; a lens driver configured to change the projection lens through which the image content is projected; a memory storing one or more instructions; and at least one processor configured to execute the one or more instructions to: identify a position at which the image content is to be projected, based on the position at which the image content is to be projected, identify whether to move the movable projection device and identify whether to change the projection lens, and based on identifying to move the movable projection device and identifying to change the projection lens, control the lens driver to change the projection lens from the one of the first lens or the second lens to another of the first lens or the second lens, in a moving state of the movable projection device.

The first lens may include at least one of a short-focal-length lens or an ultra-short-focal-length lens, where the second lens includes a long-focal-length lens.

The movable projection device may further include a driver configured to perform a traveling movement of the movable projection device and perform a rotational movement of the projector, where the at least one processor is further configured to execute the one or more instructions to, in the moving state of the movable projection device, control the driver to perform the traveling movement of the movable projection device or to perform the rotational movement of the projector.

The at least one processor may be further configured to execute the one or more instructions to identify whether to change the projection lens, based on information about the projection lens and information about a lens corresponding to the position at which the image content is to be projected.

The at least one processor may be further configured to execute the one or more instructions to, in the moving state of the movable projection device, pause the image content and control the projector to not project the image content.

The movable projection device may further include a sensor configured to obtain information about a surrounding environment of the movable projection device, where the at least one processor is further configured to execute the one or more instructions to identify the position at which the image content is to be projected, based on the information about the surrounding environment of the movable projection device.

The information about the surrounding environment may include at least one of a position, a size, and a type of a screen, or a type, a size, a position, and movement information of an object.

The at least one processor may be further configured to execute the one or more instructions to: obtain user information, and based on the user information, identify the position at which the image content is to be projected.

The user information may include at least one of position information about a user, posture information about the user, lifestyle pattern information about the user, or information about a history of using the movable projection device by the user.

The at least one processor may be further configured to execute the one or more instructions to: identify a gaze direction of the user based on the posture information about the user, identify the position at which the image content is to be projected according to the gaze direction of the user, and identify whether to move the movable projection device and identify whether to change the projection lens, based on the position at which the image content is to be projected according to the gaze direction of the user.

According to an aspect of the disclosure, provided is a method of operating a movable projection device that includes a projector including a first lens having a first focal length and a second lens having a second focal length greater than the first focal length, and a lens driver configured to change a projection lens through which image content is projected, the method may include: identifying a position at which the image content is to be projected; based on the position at which the image content is to be projected, identifying whether to move the movable projection device and identifying whether to change the projection lens; based on identifying to move the movable projection device and identifying to change the projection lens, changing the projection lens from one of the first lens or the second lens to another of the first lens or the second lens, in a moving state of the movable projection device; and projecting the image content.

The first lens may include at least one of a short-focal-length lens or an ultra-short-focal-length lens, where the second lens includes a long-focal-length lens.

The movable projection device may further include a driver configured to perform a traveling movement of the movable projection device and perform a rotational movement of the projector, where the changing the projection lens in the moving state includes: changing the projection lens in a state of controlling the driver to perform the traveling movement of the movable projection device or in a state of controlling the driver to perform the rotational movement of the projector.

The identifying whether to change the projection lens may be based on information about the projection lens, and information about a lens corresponding to the position at which the image content is to be projected.

The method may further include, in the moving state of the movable projection device, pausing the image content and controlling the projector to not project the image content.

The method may further include obtaining information about a surrounding environment of the movable projection device, where the identifying the position at which the image content is to be projected is based on the information about the surrounding environment of the movable projection device.

The information about the surrounding environment may include at least one of a position, a size, and a type of a screen, or a type, a size, a position, and movement information of an object.

The method may further include obtaining user information, where the identifying the position at which the image content is to be projected is based on the user information.

The user information may include at least one of position information about a user, posture information about the user, lifestyle pattern information about the user, or information about a history of using the movable projection device by the user.

According to an aspect of the disclosure, provided is a non-transitory computer-readable recording medium having stored therein a program that, when executed, causes one or more processors to execute a method that may include: identifying a position at which image content is to be projected; based on the position at which the image content is to be projected, identifying whether to move a movable projection device and identifying whether to change a projection lens through which the image content is projected; based on identifying to move the movable projection device and identifying to change the projection lens, changing the projection lens from one of a first lens or a second lens to another of the first lens or the second lens, in a moving state of the movable projection device; and projecting the image content.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a projection device according to an embodiment of the disclosure;

FIG. 2 is a diagram illustrating an operation of a lens driving unit according to an embodiment of the disclosure;

FIG. 3 is a flowchart of a method, performed by a projection device, of moving the projection device or changing a projection lens, and then projecting image content, according to an embodiment of the disclosure;

FIG. 4 is a diagram illustrating an example in which a movement of a projection device and a change of a projection lens are to be performed, according to an embodiment of the disclosure;

FIG. 5 is a diagram illustrating an example in which a movement of a projection device and a change of a projection lens are to be performed, according to an embodiment of the disclosure;

FIG. 6 is a flowchart of a method of operating a projection device, according to an embodiment of the disclosure;

FIG. 7 is a diagram illustrating an operation, performed by a projection device, of setting a projection lens based on information about a surrounding environment, according to an embodiment of the disclosure;

FIG. 8 is a diagram illustrating an operation, performed by a projection device, of projecting image content, according to an embodiment of the disclosure;

FIG. 9 is a diagram illustrating an operation, performed by a projection device, of projecting image content, according to an embodiment of the disclosure;

FIG. 10 is a flowchart of a method of operating a projection device, according to an embodiment of the disclosure;

FIG. 11 is a diagram illustrating an example in which a projection device sets a projection lens based on user information, according to an embodiment of the disclosure;

FIG. 12 is a diagram illustrating an example in which a projection device sets a projection lens based on user information, according to an embodiment of the disclosure;

FIG. 13 is a diagram illustrating an example in which a projection device sets a projection lens based on user information, according to an embodiment of the disclosure;

FIG. 14 is a diagram illustrating an example in which a projection device sets a projection lens based on a position of the projection device, according to an embodiment of the disclosure;

FIG. 15 is a diagram illustrating an operation, performed by a projection device, of moving the projection device or changing a projection lens, according to an embodiment of the disclosure; and

FIG. 16 is a block diagram illustrating a configuration of a projection device, according to an embodiment of the disclosure.

### DETAILED DESCRIPTION

The terms used herein will be briefly described, and then the disclosure will be described in detail.

Although the terms used herein are selected from among common terms that are currently widely used in consideration of their functions in the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding part of the detailed description. Therefore, the terms used herein are not merely designations of the terms, but the terms are defined based on the meaning of the terms and content throughout the disclosure.

Throughout the present specification, when a part “includes” or “comprises” a component, it means that the part may additionally include other components rather than excluding other components as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

Hereinafter, embodiments of the disclosure will be described with reference to the accompanying drawings in such a manner that the embodiments of the disclosure may be easily carried out by those of skill in the art. The disclosure may, however, be embodied in many different forms and should not be construed as being limited to an embodiment of the disclosure set forth herein. In order to clearly describe the disclosure, portions that are not relevant to the description of the disclosure are omitted in the drawings, and similar reference numerals are assigned to similar elements throughout the present specification.

In an embodiment of the disclosure, the term “user” refers to a person who controls systems, functions, or operations, and may include a developer, an administrator, or an installer.

In addition, in an embodiment of the disclosure, the term ‘image’ or ‘picture’ may refer to a still image, a moving image consisting of a plurality of continuous still images (or frames), or a video.

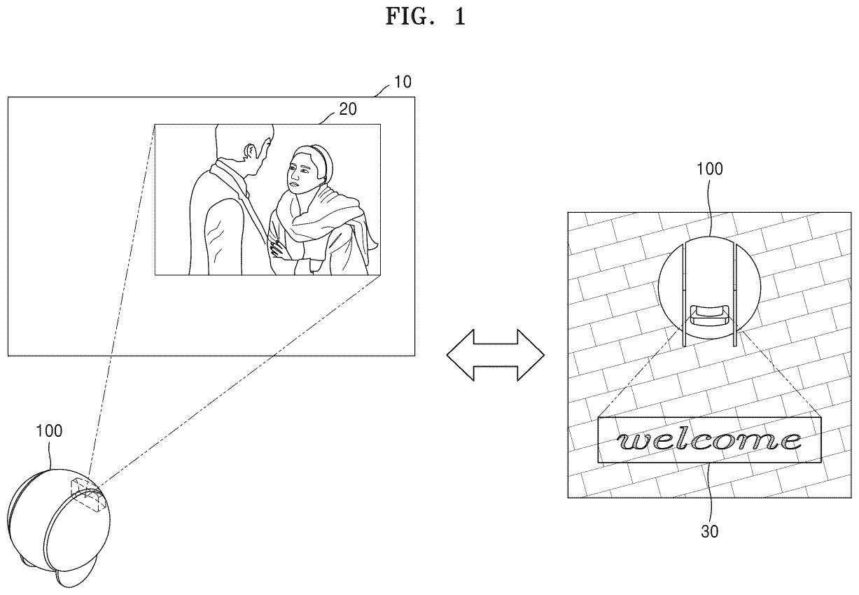

FIG. 1 is a diagram illustrating a projection device according to an embodiment of the disclosure.

Referring to FIG. 1, a projection device 100 according to an embodiment of the disclosure may project an image onto a screen. The screen onto which an image is projected may be configured in various forms. In a case in which the projection device 100 according to an embodiment of the disclosure is a projector, the screen may refer to a physical space into which an image is projected. For example, the screen may include a wall, a floor, a ceiling, a screen made of cloth, or the like. However, the disclosure is not limited thereto.

In a case in which the projection device 100 according to an embodiment of the disclosure is a device for providing virtual reality (VR), augmented reality (AR), or mixed reality (MR), the screen may refer to a display included in the projection device 100. For example, the device for providing VR, AR, or MR may be implemented in the form of a glasses-type wearable device including a head-mounted display (HMD) that is mountable on a wearer's head, and may include a display. The display may be a transparent display or an opaque display. The device for providing VR, AR, or MR may output (display) image content to the display.

Hereinafter, for convenience of descriptions, a case in which the projection device 100 is a projector will be illustrated and described as an example, but the description may also be applied to cases in which the projection device 100 is a device for providing VR, AR, or MR.

The projection device 100 according to an embodiment of the disclosure may include a projector including a first lens having a first focal length, and a second lens having a second focal length that is greater than the first focal length. For example, the first lens may include a short-focal-length lens or an ultra-short-focal-length lens, and the second lens may include a long-focal-length lens.

Hereinafter, for convenience of descriptions, it will be assumed that the first lens is a short-focal-length lens or an ultra-short-focal-length lens, and the second lens is a long-focal-length lens.

The projection device 100 according to an embodiment of the disclosure may identify a position at which image content is to be projected, a size and a shape of an area onto which the image content is to be projected, and the like, and project the image content based on the identified information by using the first lens or the second lens as a projection lens.

According to an embodiment of the disclosure, when projecting image content onto a screen or a space that is far away (spaced a preset distance or more) from the projection device 100, the projection device 100 may project the image content by using the second lens. For example, as illustrated in FIG. 1, when projecting second image content 20 onto a wall 10 that is far away from the projection device 100, the projection device 100 may project the second image content 20 by using the second lens.

According to an embodiment of the disclosure, when projecting image content onto a screen or a space that is close to (within a preset distance or less from) the projection device 100, the projection device 100 may project the image content by using the first lens. For example, as illustrated in FIG. 1, when projecting first image content 30 onto a floor that is close to the projection device 100, the projection device 100 may project the first image content 30 by using the first lens.

According to an embodiment of the disclosure, when the projection device 100 is projecting image content onto a distant screen or a distant space by using the second lens, and then needs to project image content onto a nearby screen or a nearby space, the projection device 100 may change the projection lens from the second lens to the first lens.

According to an embodiment of the disclosure, when the projection device 100 is projecting image content onto a nearby screen or a nearby space by using the first lens, and then needs to project image content onto a distant screen or a distant space, the projection device 100 may change the projection lens from the first lens to the second lens.

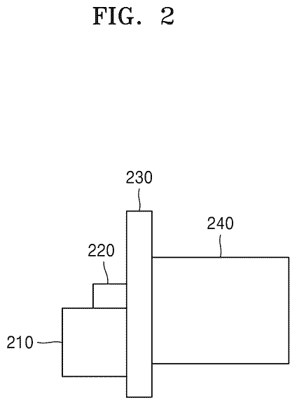

The projection device 100 according to an embodiment of the disclosure may change the projection lens by using a lens driver. This will be described in detail with reference to FIG. 2. An operation in which the projection device 100 changes the projection lens from the first lens to the second lens, or from the second lens to the first lens, takes a certain amount of time. A user of the projection device 100 experiences the inconvenience of having to wait during the lens change operation, and viewing of image content may be interrupted by the time required for the lens change operation.

In addition, the projection device 100 according to an embodiment of the disclosure may be movable. The projection device 100 may include a driver and may be movable via the driver. Movement of the projection device 100 may include not only traveling movement where the position of the projection device 100 changes as the projection device 100 travels, but also rotational movement where the projection device 100 rotates to change a projection direction without changing its position. However, the disclosure is not limited thereto.

According to an embodiment of the disclosure, when both a movement of the projection device 100 and a change of the projection lens are to be performed, the projection device 100 may change the projection lens while the projection device is moving so as to save the time required for changing the lens.

Hereinafter, with reference to the following drawings, operations of the projection device 100 according to an embodiment of the disclosure will be described in detail, including identifying a projection position for image content, moving, when a movement of the projection device or a change of the projection lens is to be performed based on the identified projection position, the projection device or changing the projection lens, and projecting the image content.

FIG. 2 is a diagram illustrating an operation of a lens driver according to an embodiment of the disclosure.

Referring to FIG. 2, a lens driver according to an embodiment of the disclosure may include a sliding-type structure 230. A first lens 210 and a second lens 220 may be arranged on one side of the sliding-type structure 230. The first lens 210 may include a short-focal-length lens or an ultra-short-focal-length lens, and the second lens 220 may include a long-focal-length lens. For example, the lens driver may move the sliding-type structure 230 such that the first lens 210 or the second lens 220 is aligned with the center of an optical system 240. The optical system 240 may include optical components used by the projection device 100 to project image content.

The lens driver according to an embodiment of the disclosure may include a motor, a rail, or the like, and may move the sliding-type structure 230 by using the motor, the rail, or the like. In some embodiments, the lens driver may include a rack-and-pinion structure. The rack-and-pinion structure is a type of structure that converts a rotational motion into a linear motion, and may include a rack gear and a pinion gear. The rack gear is a rod in the shape of a long, flat gear and is capable of linear motion, and the pinion gear is a small circular gear and is capable of rotational motion. When the pinion gear rotates, the rack gear, which is engaged with the pinion gear, moves to convert the rotational motion into a linear motion. According to an embodiment of the disclosure, the first lens 210 and the second lens 220 are connected to the rack gear so as to move as the rack gear moves. However, the disclosure is not limited thereto.

Referring to FIG. 2, the sliding-type structure 230 may move (or slide) in a first direction and a second direction that is opposite to the first direction. For example, when a change of the projection lens from the second lens 220 to the first lens 210 is to be performed while the second lens 220 is aligned with the central axis of the optical system 240, the sliding-type structure 230 may be moved (or slid) in the second direction (e.g., upward) to control the first lens 210 to be aligned with the central axis of the optical system 240. In a case in which the lens driver includes a rack-and-pinion structure, the rack gear may be moved in the first direction and the second direction. For example, when a change of the projection lens from the second lens 220 to the first lens 210 is to be performed while the second lens 220 is aligned with the central axis of the optical system 240, the lens driver may move the rack gear in the second direction (e.g., upward) to control the first lens 210 to be aligned with the central axis of the optical system 240. Accordingly, the projection device 100 may project image content through the first lens 210.

On the contrary, when a change of the projection lens from the first lens 210 to the second lens 220 is to be performed while the first lens 210 is aligned with the central axis of the optical system 240, the sliding-type structure 230 may be moved (or slid) in the first direction (e.g., downward) to control the second lens 220 to be aligned with the central axis of the optical system 240. In a case in which the lens driver includes a rack-and-pinion structure, when a change the projection lens from the first lens 210 to the second lens 220 is to be performed while the first lens 210 is aligned with the central axis of the optical system 240, the lens driver may move the rack gear in the first direction (e.g., downward) to control the second lens 220 to be aligned with the central axis of the optical system 240. Accordingly, the projection device 100 may project image content through the second lens 220.

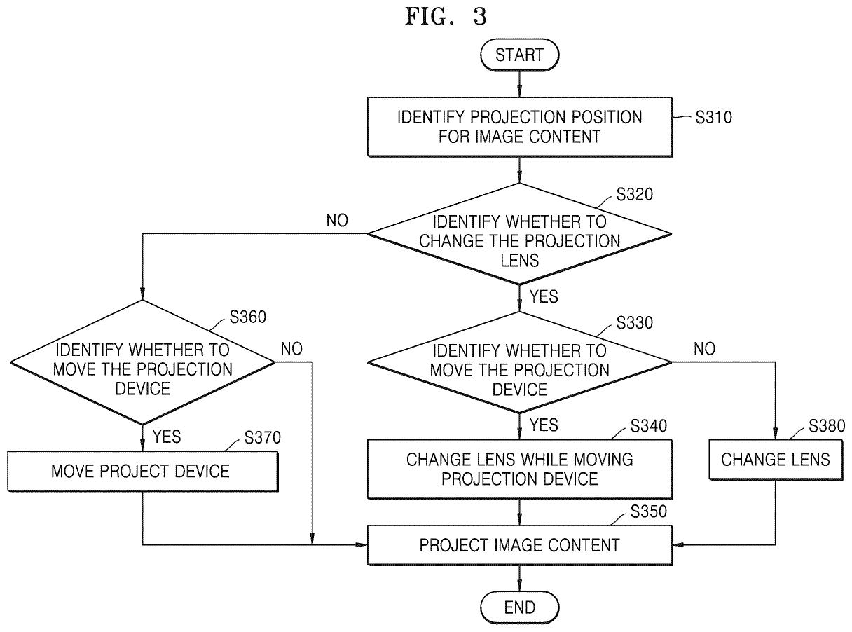

FIG. 3 is a flowchart of a method, performed by a projection device, of moving the projection device or changing a projection lens, and then projecting image content, according to an embodiment of the disclosure.

Referring to FIG. 3, the projection device 100 according to an embodiment of the disclosure may identify a projection position for image content (S310).

For example, the projection device 100 may obtain information about the surrounding environment of the projection device 100 and, based on the information about the surrounding environment, determine a position at which the image content is to be projected. The projection device 100 may obtain information about the surrounding environment based on information sensed by using a sensor unit. The information about the surrounding environment may include at least one of the size, position, or type of a screen located around the projection device 100, the type, size, or position of an object located around the projection device 100, or information about a movement of an object. However, the disclosure is not limited thereto. In addition, the projection device 100 may determine a position at which the image content is to be projected, based on information about the image content to be projected.

For example, when the image content to be projected is a media image (e.g., a movie), the projection device 100 may identify whether a screen having a size greater than or equal to a preset value exists around the projection device 100, in order to project the media image. When a screen having a size greater than or equal to the preset value is identified around the projection device 100, the projection device 100 may determine the position of the screen as the position at which the movie is to be projected.

In addition, when the image content to be projected is an image that provides a message or information, the projection device 100 may determine a nearby floor or wall as the position at which the image content is to be projected.

In addition, the projection device 100 may preferentially determine, as the projection position, a position at which the image content may be projected by using the currently set projection lens from among candidate projection positions to which the image content may be projected. Here, the projection device 100 may have been set, based on a user input, to determine, as the projection position, a position that involves a minimal change of the projection lens. However, the disclosure is not limited thereto.

In addition, the projection device 100 may determine the position at which the image content is to be projected, based on a user input such as a user voice command or a user's motion (gesture). For example, based on receiving the user's voice saying “Project it on the living room wall,” the projection device 100 may determine the living room wall as the position at which the image content is to be projected. In some embodiments, based on recognizing a gesture of the user pointing a finger at a floor, the projection device 100 may determine a floor area pointed to by the user's finger, as the position at which the image content is to be projected.

However, the disclosure is not limited thereto, and the projection device 100 according to an embodiment of the disclosure may identify a position at which image content is to be projected, in various ways.

The projection device 100 according to an embodiment of the disclosure may identify whether to change the projection lens (S320).

The projection device 100 according to an embodiment of the disclosure may identify whether to change the projection lens, based on information about the currently set projection lens and the projection lens identified to project the image content to the projection position that is identified in operation S310. For example, when the currently set projection lens is the first lens (a short-focal-length lens or an ultra-short-focal-length lens), and the identified projection position is spaced a preset distance or more from the projection device 100, the projection device 100 may identify that a change of the projection lens should be performed, because the second lens (a long-focal-length lens) is identified to project the image content to the projection position. When the currently set projection lens is the second lens, and the identified projection position is close to the projection device 100, the projection device 100 may identify that a change of the projection lens is to be performed because the first lens is identified to project the image content to the projection position.

In addition, when the projection device 100 is projecting first image content providing a message or information (e.g., a welcome message image, an image including an emotion expression, an image providing information such as a door opened, a window opened, or gas leakage, or an image providing weather information) onto the floor of a living room or an entrance by using the first lens, and needs to project second image content (e.g., media content or an augmented reality background image) on a wall or the like based on a user input, the projection device 100 may identify that a change of the projection lens is to be performed, because the second lens is identified to project the second image content.

In addition, when the projection device 100 is projecting second image content onto a wall or the like by using the second lens, and needs to project first image content onto a floor, the projection device 100 may identify that a change of the projection lens is to be performed, because the first lens is to be used to project the first image content.

The projection device 100 according to an embodiment of the disclosure may identify whether to move the projection device (S330 and S360).

The projection device 100 according to an embodiment of the disclosure may identify whether to move the projection device 100 to project the image content to the projection position that is identified in operation S310. For example, in order to project the image content to the projection position, the projection device 100 may need to perform a traveling movement to change its position, or a rotational movement to change the projection direction without changing its position.

According to an embodiment of the disclosure, when both a change of the projection lens and a movement of the projection device 100 to be performed, the projection device 100 may change the projection lens while the projection device 100 is moving (S340).

For example, the projection device 100 may change the projection lens from the first lens to the second lens, or from the second lens to the first lens, while moving.

As described above with reference to FIG. 2, the operation of changing the projection lens is performed by the mechanical driving of the lens driver, and changing the lens takes approximately 4 seconds. Accordingly, the user may experience the inconvenience of having to wait while the lens change operation is performed. Thus, performing the lens change operation while the projection device 100 is moving may save the waiting time required for the lens change operation.

According to an embodiment of the disclosure, when the projection device 100 is projecting the image content, the projection device 100 may pause the playback of the image content and stop the projection during the change of the projection lens and the movement of the projection device.

According to an embodiment of the disclosure, when the image content being played back is advertisement content, the projection device 100 may continuously play back the advertisement content without pausing it and stop only the projection, even during the change of the projection lens and the movement of the projection device.

According to an embodiment of the disclosure, in a case in which the projection device 100 includes a cover or the like capable of opening and closing the projector, the projection device 100 may control the cover to be closed during the change of the projection lens and the movement of the projection device, so as to prevent the image content from being projected onto the screen.

In addition, the projection device 100 according to an embodiment of the disclosure may notify the user that the change of the projection lens and the movement of the projection device are in progress, through a light-emitting diode (LED) module, an audio output module, or the like included in the projection device 100.

According to an embodiment of the disclosure, when a change of the projection lens is to be performed, but a movement of the projection device is not to be performed, the projection device 100 may change the projection lens from the first lens to the second lens, or from the second lens to the first lens (S380).

According to an embodiment of the disclosure, when the projection device 100 is projecting the image content, the projection device 100 may pause the playback of the image content and stop the projection during the change of the projection lens.

Alternatively, according to an embodiment of the disclosure, when the image content being played back is advertisement content, the projection device 100 may continuously play back the advertisement content without pausing it and stop only the projection, even during the change of the projection lens.

According to an embodiment of the disclosure, in a case in which the projection device 100 includes a cover or the like capable of opening and closing the projector, the projection device 100 may control the cover to be closed during the change of the projection lens, so as to prevent the image content from being projected onto the screen.

In addition, the projection device 100 according to an embodiment of the disclosure may notify the user that the change of the projection lens is in progress, through an LED module, an audio output module, or the like included in the projection device 100.

According to an embodiment of the disclosure, when a movement of the projection device is to be performed, but a change of the projection lens is not to be performed, the projection device 100 may move the projection device (S370).

The projection device 100 according to an embodiment of the disclosure may perform traveling movement or rotational movement through the driver.

According to an embodiment of the disclosure, when the projection device 100 is projecting the image content, the projection device 100 may pause the playback of the image content and stop the projection during the movement of the projection device.

Alternatively, according to an embodiment of the disclosure, when the image content being played back is advertisement content, the projection device 100 may continuously play back the advertisement content without pausing it and stop only the projection, even during the movement of the projection device.

According to an embodiment of the disclosure, in a case in which the projection device 100 includes a cover or the like capable of opening and closing the projector, the projection device 100 may control the cover to be closed during the movement of the projection device, so as to prevent the image content from being projected onto the screen.

In addition, the projection device 100 according to an embodiment of the disclosure may notify the user that the movement of the projection device is in progress, through an LED module, an audio output module, or the like included in the projection device 100.

The projection device 100 according to an embodiment of the disclosure may project the image content based on the changed position or the changed projection lens (S350).

It is illustrated in FIG. 3 and described that the projection device 100 identifies whether to move the projection device and then identifies whether to change the projection lens, but the disclosure is not limited thereto. The projection device 100 according to an embodiment of the disclosure may identify whether to move the projection device and then identify whether to change the projection lens. The projection device 100 according to an embodiment of the disclosure may identify whether to change the projection lens while identifying whether to move the projection device.

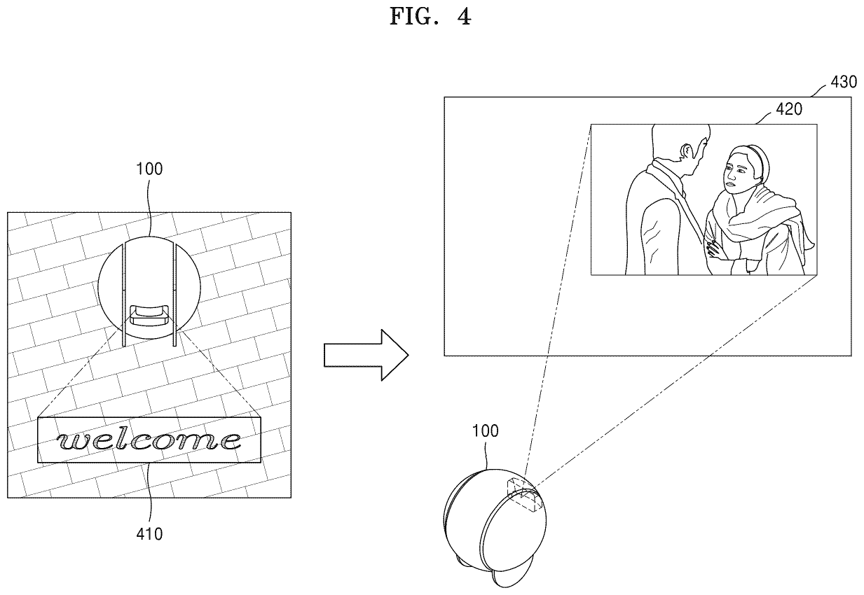

FIG. 4 is a diagram illustrating an example in which a movement of a projection device and a change of a projection lens are to be performed, according to an embodiment of the disclosure.

Referring to FIG. 4, the projection device 100 according to an embodiment of the disclosure may perform a welcome operation when the user returns home. For example, the projection device 100 may move near an entrance and then project first image content 410 including a welcome message, onto the floor of the entrance or onto a floor near the entrance. Here, the projection device 100 may project the first image content 410 onto the floor of the entrance, a floor near the entrance, or the like, by using the first lens (a short-focal-length lens or an ultra-short-focal-length lens).

According to an embodiment of the disclosure, the projection device 100 projecting the first image content 410 may receive a user input or the like for requesting projection of second image content 420. Here, the second image content 420 may be media content such as a movie or a television program. However, the disclosure is not limited thereto.

The projection device 100 may identify that the projection position for the second image content 420 is a screen (e.g., a wall) located in a room or a living room, and may identify that the second lens (a long-focal-length lens) is to project the second image content 420.

The projection device 100 according to an embodiment of the disclosure may change the projection lens from the first lens to the second lens, while moving from the entrance to the room or living room. The projection device 100 may project the second image content 420 onto a screen 430 that is far away (spaced a preset distance or more) from the projection device 100 by using the second lens.

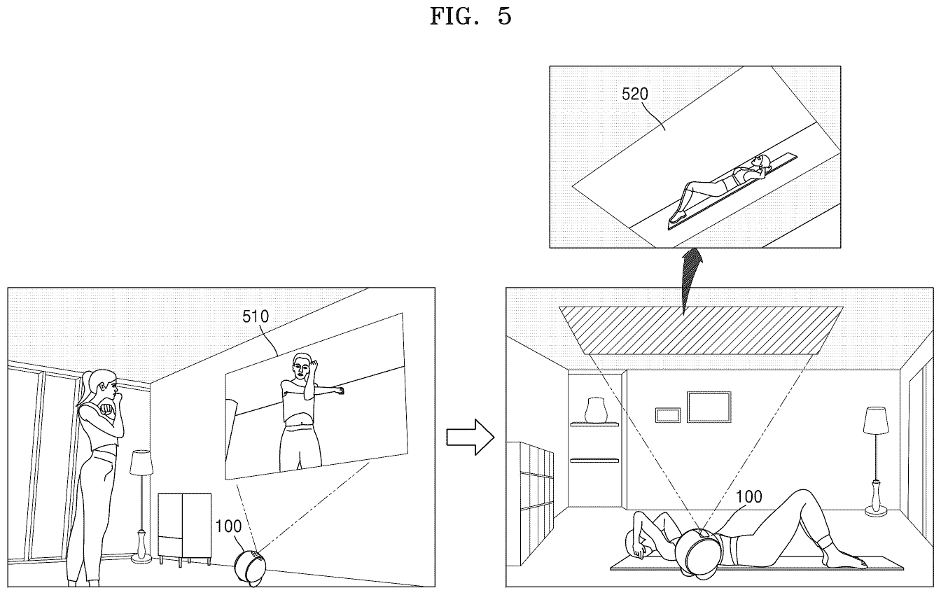

FIG. 5 is a diagram illustrating an example in which a movement of a projection device and a change of a projection lens are to be performed, according to an embodiment of the disclosure.

Referring to FIG. 5, the projection device 100 according to an embodiment of the disclosure may project exercise content. For example, the projection device 100 may project a first exercise image 510 that guides a first exercise motion. Here, the first exercise motion may be a standing motion, and the projection device 100 may project the first exercise image onto a wall that is close to (within a preset distance or less from) the projection device 100. Here, the projection device 100 may project the first exercise image by using the first lens (a short-focal-length lens or an ultra-short-focal-length lens).

The image content being projected may be changed from the first exercise image to a second exercise image 520 that guides a second exercise motion. Here, the second exercise motion may be a lying-down motion. The projection device 100 may identify, based on information about the second exercise image 520, that the second exercise motion in the second exercise image 520 is a lying-down motion. In some embodiments, the projection device 100 may receive a request to change the projection position for the second exercise image 520 to a ceiling.

Accordingly, the projection device 100 may determine that the projection position for the second exercise image 520 is the ceiling. The projection device 100 may identify, in order to project the second exercise image 520 onto the ceiling, to rotate the projector such that the projection direction of the projection device 100 is toward the ceiling, and that the second lens (a long-focal-length lens) is to be used to project the content.

The projection device 100 according to an embodiment of the disclosure may change the projection lens from the first lens to the second lens while rotating the projector by using the driver. The projection device 100 may project the second exercise image 520 onto the ceiling by using the second lens.

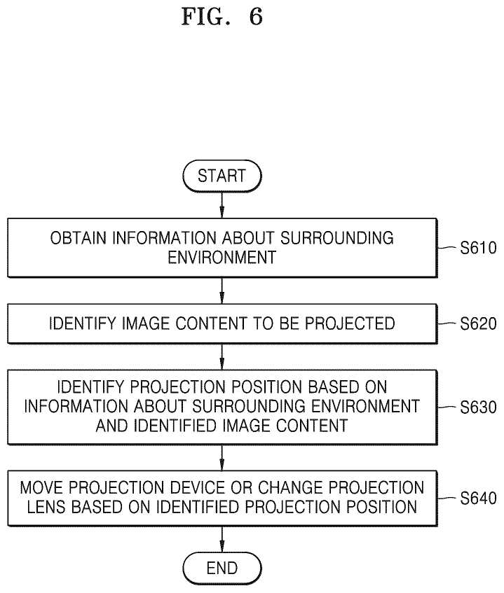

FIG. 6 is a flowchart of a method of operating a projection device, according to an embodiment of the disclosure.

Referring to FIG. 6, the projection device 100 according to an embodiment of the disclosure may obtain information about the surrounding environment (S610).

For example, the projection device 100 may sense various pieces of information by using a distance measuring sensor, a camera, an image sensor, a depth sensor, an infrared sensor, a gyro sensor, an acceleration sensor, and the like. The projection device 100 may obtain information about the surrounding environment based on the sensed information.

The information about the surrounding environment may include at least one of the size, position, or type of a screen located around the projection device 100, the type, size, or position of an object located around the projection device 100, or information about a movement of an object.

The projection device 100 according to an embodiment of the disclosure may identify image content to be projected (S620).

For example, the projection device 100 may obtain information about the type and content of the image content to be projected, and the size, position, and the like of a screen suitable for projecting the image content.

The projection device 100 according to an embodiment of the disclosure may identify a projection position based on the information about the surrounding environment and the identified image content (S630).

For example, the projection device 100 may identify screens located around the projection device 100 and determine, as the projection position, the most suitable screen for projecting the image content. In a case in which the projection position corresponding to the identified image content is preset, the projection device 100 may determine the preset position as the projection position. However, the disclosure is not limited thereto.

The projection device 100 according to an embodiment of the disclosure may identify, based on the identified projection position, whether to perform a movement of the projection device and whether to perform a change of the projection lens.

The projection device 100 according to an embodiment of the disclosure may move the projection device or change the projection lens (S640).

When a movement of the projection device and a change of the projection lens are to be performed, the projection device 100 may change the projection lens while moving the projection device 100. This process has been described above in detail with reference to operation S340 of FIG. 3, and thus, a detailed description thereof will be omitted.

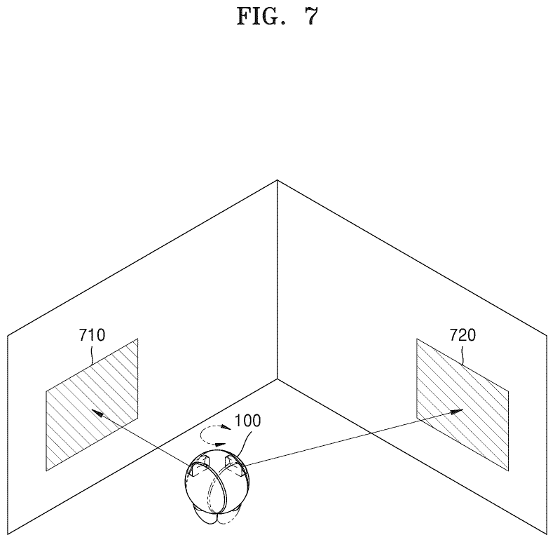

FIG. 7 is a diagram illustrating an operation, performed by a projection device, of setting a projection lens based on information about a surrounding environment, according to an embodiment of the disclosure.

Referring to FIG. 7, the projection device 100 according to an embodiment of the disclosure may identify nearby screens. For example, the projection device 100 may determine a first area 710 and a second area 720 as candidate projection areas.

The projection device 100 according to an embodiment of the disclosure may receive a request for projection of image content.

The projection device 100 according to an embodiment of the disclosure may determine a projection area based on image content to be projected. For example, when the image content to be projected is an image that provides a message or information, it may be appropriate to project the image content onto a narrow area near the user. Accordingly, the projection device 100 may determine the first area 710 as a projection position. In some embodiments, when the image content to be projected is media content, it may be appropriate to project the image content onto an area that is spaced a preset distance or more from the user. Accordingly, the projection device 100 may determine the second area 720 as the projection position.

In some embodiments, the projection device 100 may determine the projection position based on a user input for selecting any one of the candidate areas 710 and 720 as the projection area.

According to an embodiment of the disclosure, when projecting the image content onto the first area 710, the projection device 100 may project the image content by using the first lens. In addition, when projecting the image content onto the second area 720, the projection device 100 may project the image content by using the second lens.

The projection device 100 according to an embodiment of the disclosure may receive a user input for requesting a change of the projection position for the image content.

For example, the projection device 100 may receive a user input for changing the projection position from the first area 710 to the second area 720. The projection device 100 may rotate the projector by using the driver such that the projection direction is toward the second area 720. In addition, the projection device 100 may change the projection lens from the first lens to the second lens while performing a rotational movement. The projection device 100 may project the image content onto the second area 720 by using the second lens.

In some embodiments, the projection device 100 may receive a user input for changing the projection position from the second area 720 to the first area 710. The projection device 100 may rotate the projector by using the driver such that the projection direction is toward the first area 710. In addition, the projection device 100 may change the projection lens from the second lens to the first lens while performing a rotational movement. The projection device 100 may project the image content onto the first area 710 by using the first lens.

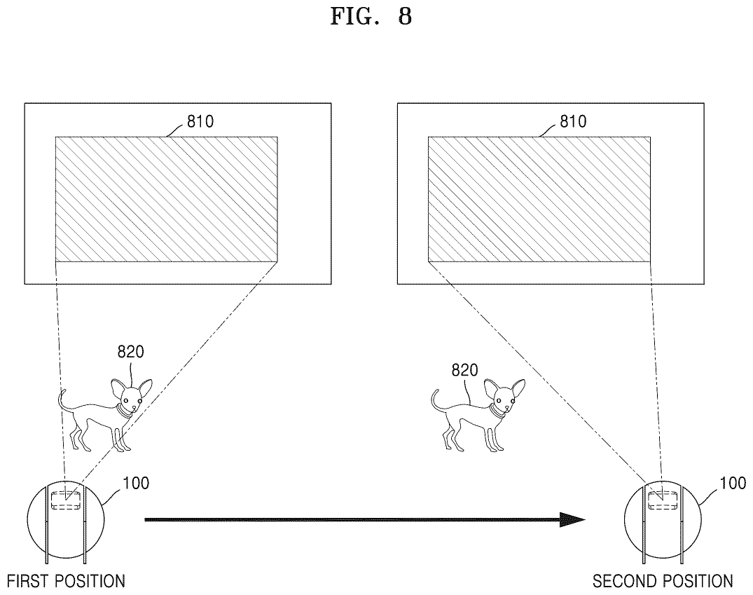

FIG. 8 is a diagram illustrating an operation, performed by a projection device, of projecting image content, according to an embodiment of the disclosure.

Referring to FIG. 8, the projection device 100 according to an embodiment of the disclosure may project image content 810 onto a screen.

The projection device 100 may detect objects located around the projection device 100. For example, as illustrated in FIG. 8, the projection device 100 may detect objects located on a projection path at preset intervals by using a camera (an image sensor) or the like. Here, the objects located on the projection path may include a moving object 820 (e.g., a dog or a cat). As illustrated in FIG. 8, the moving object 820 is located on the path along which the projection device 100 projects the image content 810, and thus may obstruct the projection of the image content 810. Accordingly, the projection device 100 may move to a position where the projection is not obstructed by the moving object 820.

According to an embodiment of the disclosure, when the projection device 100 detects the moving object 820 while projecting the image content 810 by using the second lens (a long-focal-length lens) at a first position, the projection device 100 may move to a position where it may avoid the moving object 820. Here, the projection device 100 may move to a second position where a change of the projection lens is not to be performed. For example, at the second position, the projection device 100 may project the image content 810 by using the second lens (a long-focal-length lens) without being obstructed by the moving object 820.

In addition, while moving from the first position to the second position, the projection device 100 may continuously project the image content 810 while adjusting the projection direction without stopping the playback and projection of the image content 810.

The projection device 100, having moved to the second position, may continuously project the image content 810 by using the second lens, without changing the projection lens.

Accordingly, even when the projection device moves from the first position to the second position, the user may continuously watch the image content 810 being projected.

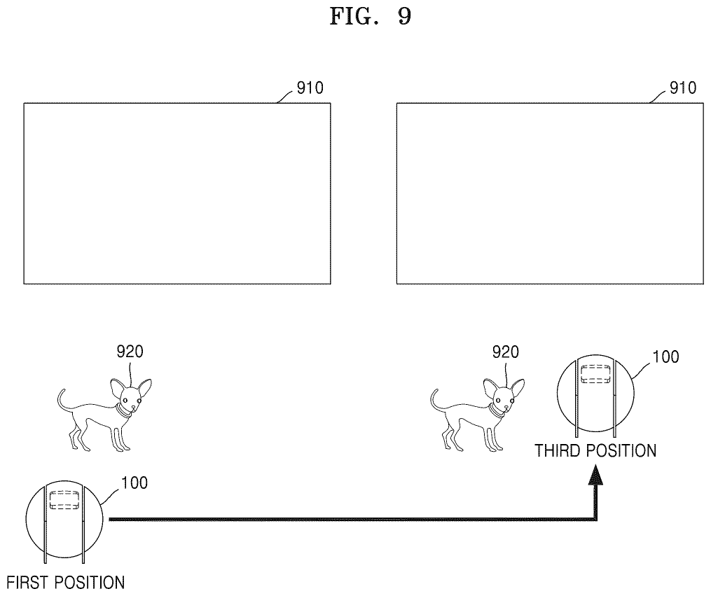

FIG. 9 is a diagram illustrating an operation, performed by a projection device, of projecting image content, according to an embodiment of the disclosure.

Referring to FIG. 9, the projection device 100 according to an embodiment of the disclosure may detect nearby objects. For example, as illustrated in FIG. 9, at a first position, the projection device 100 may detect a moving object 920 (e.g., a dog or a cat) around the projection device 100. The moving object 920 may be located between a screen 910 and the projection device 100. Here, the projection device 100 may not be projecting image content.

The projection device 100 may move to a position where projection is not obstructed by the moving object 920.

According to an embodiment of the disclosure, when the projection device 100 is not projecting image content, the projection device 100 may move to a position where projection is less likely to be obstructed even through the position requires a change of the projection lens. For example, a third position may be where projection is less likely to be obstructed by the moving object 920. The projection device 100 may have been set, at the first position, to use the second lens (a long-focal-length lens), and may change the projection lens from the second lens to the first lens (a short-focal-length lens or an ultra-short-focal-length lens) while moving from the first position to the third position.

After the projection device 100 moves to the third position, based on receiving a request for projection of image content, the projection device 100 may project the image content onto the screen by using the first lens.

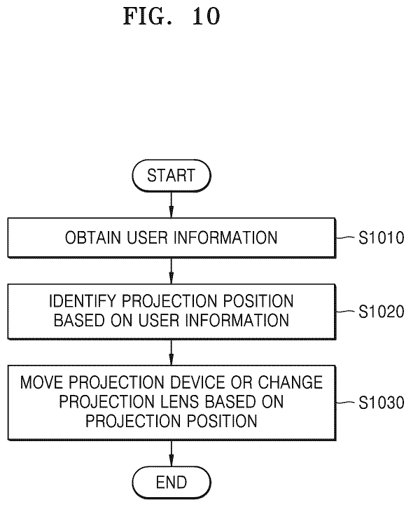

FIG. 10 is a flowchart of a method of operating a projection device, according to an embodiment of the disclosure.

Referring to FIG. 10, the projection device 100 according to an embodiment of the disclosure may obtain user information (S1010).

The user information may include at least one of the user's position, the user's posture, information about the user's life pattern, information about a usage history of the projection device, or the user's age or gender. However, the disclosure is not limited thereto.

The projection device 100 according to an embodiment of the disclosure may identify a projection position for image content based on the user information (S1020).

For example, the projection device 100 may analyze the user's position, state, posture, motion, and the like, based on an image obtained by photographing the user. The projection device 100 may predict a behavior of the user based on the user's position, state, posture, motion, and the like. The projection device 100 may determine the projection position for the image content based on the predicted behavior of the user.

In addition, the projection device 100 may identify the gaze direction of the user based on the user's posture. The projection device 100 may determine an area corresponding to the gaze direction of the user, as the projection position for the image content.

In addition, the projection device 100 may predict a behavior of the user based on the information about the user's life pattern. The projection device 100 may determine the projection position for the image content based on the predicted behavior of the user.

The projection device 100 according to an embodiment of the disclosure may move the projection device or change the projection lens, based on the projection position identified in operation $1020 (S1030).

The projection device 100 according to an embodiment of the disclosure may identify, based on the identified projection position, whether to perform a movement of the projection device and whether to perform a change of the projection lens.

When performing a movement of the projection device and a change of the projection lens, the projection device 100 may change the projection lens while moving the projection device 100. This process has been described above in detail with reference to operation S340 of FIG. 3, and thus, a detailed description thereof will be omitted.

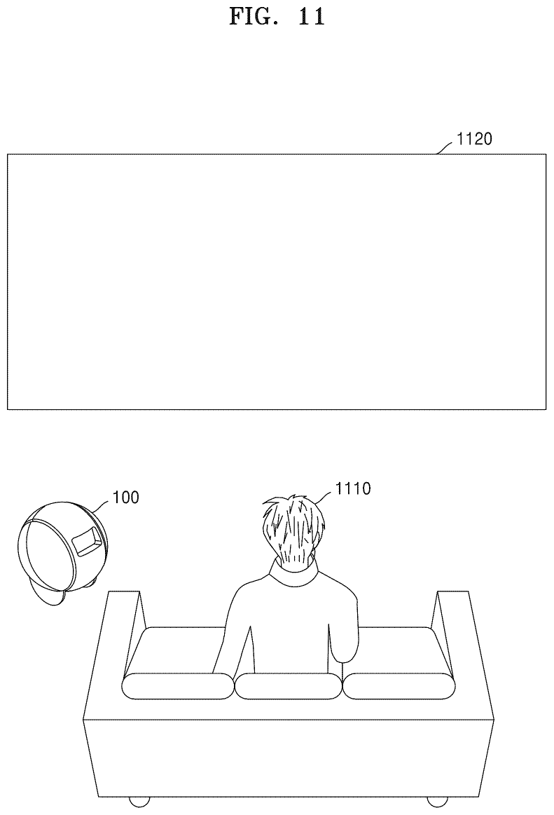

FIG. 11 is a diagram illustrating an example in which a projection device sets a projection lens based on user information, according to an embodiment of the disclosure.

Referring to FIG. 11, the projection device 100 according to an embodiment of the disclosure may photograph a user 1110 located around the projection device 100 to analyze the user's position, state, posture, motion, and the like. For example, the projection device 100 may identify that the user 1110 is sitting on a sofa and looking at a screen 1120 (e.g., a wall).

The projection device 100 according to an embodiment of the disclosure may predict a behavior of the user 1110 based on the state of the user 1110. For example, the projection device 100 may predict that the user 1110 will request projection of image content onto the screen 1120.

The projection device 100 according to an embodiment of the disclosure may change in advance the position and the projection lens state of the projection device 100 based on the predicted behavior of the user. For example, the projection device 100 may move in advance to an optimal position for projecting the image content onto the screen 1120.

The projection device 100 may change in advance the projection lens. For example, when the second lens is identified to project the image content onto the screen 1120 from the optimal position (e.g., when the optimal position is far away from the screen 1120), and the current lens state corresponds to the first lens, the projection device 100 may change the projection lens from the first lens to the second lens while moving to the optimal position.

When the first lens is identified to project the image content onto the screen 1120 from the optimal position (e.g., when the optimal position is close to the screen 1120), and the current lens state corresponds to the second lens, the projection device 100 may change the projection lens from the second lens to the first lens while moving to the optimal position.

According to an embodiment of the disclosure, by changing in advance the position and the projection lens state of the projection device 100 based on a predicted behavior of the user, the projection device 100 may perform projection immediately when a user request is received, without waiting time.

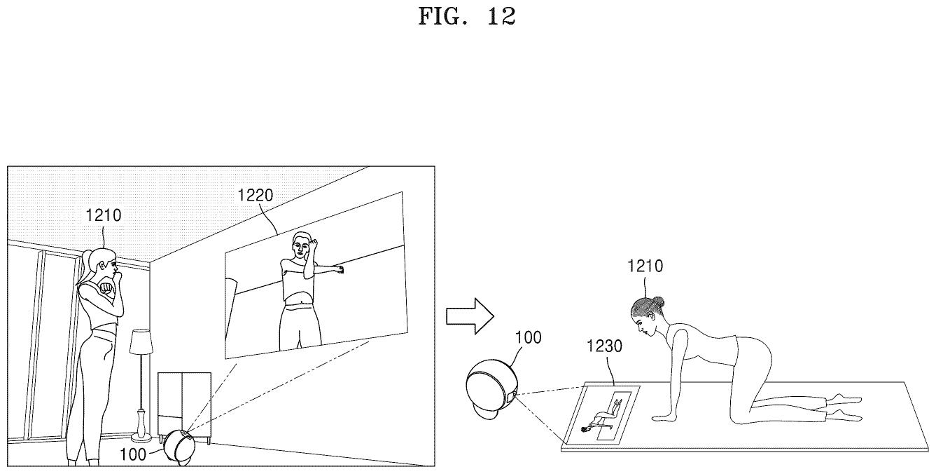

FIG. 12 is a diagram illustrating an example in which a projection device sets a projection lens based on user information, according to an embodiment of the disclosure.

Referring to FIG. 12, the projection device 100 may be projecting an exercise image 1220 onto a screen (e.g., a wall), and a user 1210 may be exercising while watching the exercise image projected on the screen. Here, the projection device 100 may project the exercise image onto the screen by using the second lens (a long-focal-length lens).

The projection device 100 according to an embodiment of the disclosure may photograph the user 1210 to analyze a position, a state, a posture, a motion, and the like of the user 1210. For example, the projection device 100 may photograph the user 1210 exercising to analyze the posture of the user 1210.

The projection device 100 may detect a change in the posture of the user 1210. For example, the projection device 100 may detect that the user 1210 has changed from exercising in a standing posture to a lying-down posture.

The projection device 100 may change the projection position based on the change in the posture of the user 1210. For example, it is difficult for the user 1210 in the lying-down posture to watch the image content projected on the screen (e.g., a wall), and the projection position may be changed to an area toward which the gaze of the user 1210 in the lying-down posture is directed.

The projection device 100 may change the position, the projection direction, or the projection lens of the projection device, based on the changed projection position. For example, the projection device 100 may rotate the projector so as to project the exercise image onto an area 1230 toward which the gaze of the user 1210 lying down is directed. In addition, the projection lens may be changed from the second lens to the first lens to project the exercise image onto the area 1230. Here, the projection device 100 may change the projection lens while rotating the projector by using the driver.

The projection device 100 according to an embodiment of the disclosure may project image content according to the gaze direction of the user by moving the projection device 100 or changing the projection lens based on the user's posture, even without a separate request from the user, thereby improving the user convenience.

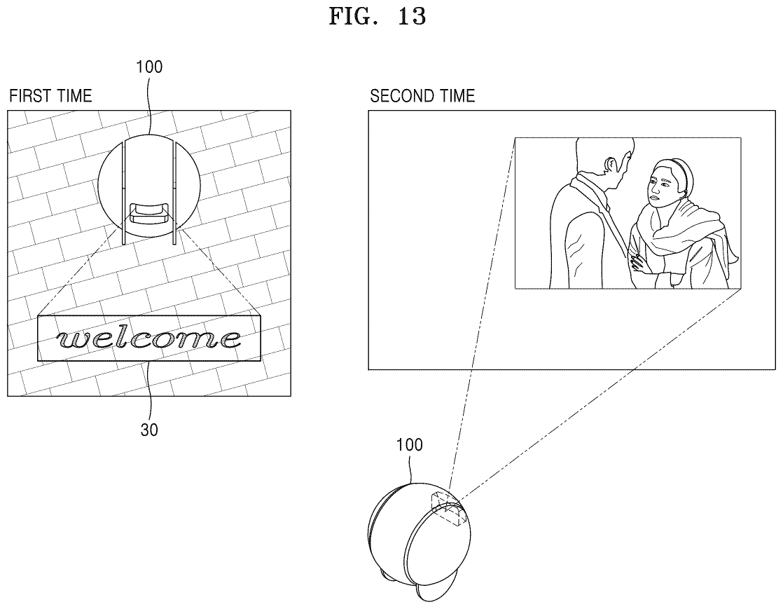

FIG. 13 is a diagram illustrating an example in which a projection device sets a projection lens based on user information, according to an embodiment of the disclosure.

Referring to FIG. 13, the projection device 100 according to an embodiment of the disclosure may predict a behavior of the user based on information about a life pattern of the user. For example, the projection device 100 may obtain information about a life pattern of the user based on a history of use of the projection device 100 by the user (an hourly usage history). In some embodiments, the projection device 100 may obtain information about a life pattern of the user based on information received from a wearable device worn by the user or a portable terminal carried by the user. For example, the projection device 100 may obtain information that the user leaves work at a first time and watches media content in a living room at a second time.

The projection device 100 according to an embodiment of the disclosure may change in advance the position and the projection lens state of the projection device 100 before the first time so as to perform a welcome operation. For example, before the first time, the projection device 100 may move near an entrance and may change the projection lens to the first lens (a short-focal-length lens or an ultra-short-focal-length lens).

In addition, the projection device 100 according to an embodiment of the disclosure may change in advance the position and the projection lens state of the projection device 100 before the second time, for projection of media content. For example, before the second time, the projection device 100 may move to the living room and may change the projection lens to the second lens (a long-focal-length lens).

In addition, the projection device 100 may change in advance the position and the projection lens state of the projection device 100 based on the user's sleeping time, wake-up time, meal time, and the like. However, the disclosure is not limited thereto.

According to an embodiment of the disclosure, by changing in advance the position and the projection lens state of the projection device 100 based on a life pattern of the user, the projection device 100 may perform projection immediately when a user request is received, without waiting time.

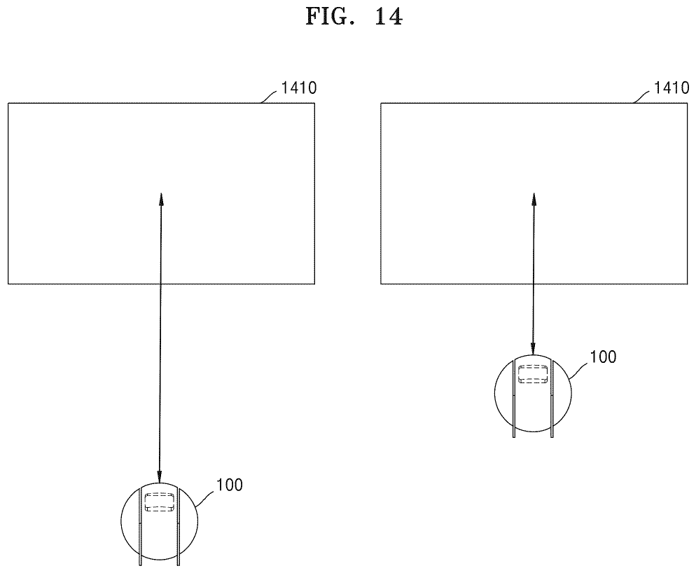

FIG. 14 is a diagram illustrating an example in which a projection device sets a projection lens based on a position of the projection device, according to an embodiment of the disclosure.

Referring to FIG. 14, the projection device 100 may obtain information about the surrounding environment. For example, the projection device 100 may obtain information such as whether a screen 1410 (e.g., a wall) exists around the projection device 100, the distance between the projection device 100 and the screen 1410, the size of the screen 1410, or a brightness around the projection device 100.

The projection device 100 according to an embodiment of the disclosure may set a projection lens based on the position of the projection device 100. For example, as illustrated in FIG. 14, when the distance between the projection device 100 and a nearby screen 1410 is long (greater than or equal to a preset distance), the projection device 100 may set the projection lens to the second lens (a long-focal-length lens). On the contrary, when the distance between the projection device 100 and the near screen 1410 is short (less than the preset distance), the projection device 100 may set the projection lens to the first lens (a short-focal-length lens or an ultra-short-focal-length lens).

In addition, according to an embodiment of the disclosure, when a brightness value around the projection device 100 is greater than or equal to a preset value (i.e., in a bright environment), the projection device 100 may set the projection lens to the first lens. On the contrary, when the brightness value around the projection device 100 is less than the preset value (i.e., in a dark environment), the projection device 100 may set the projection lens to the second lens. However, the disclosure is not limited thereto, and the projection device 100 may set the projection lens to the second lens when the ambient brightness are high, and to the first lens when the ambient brightness are low.

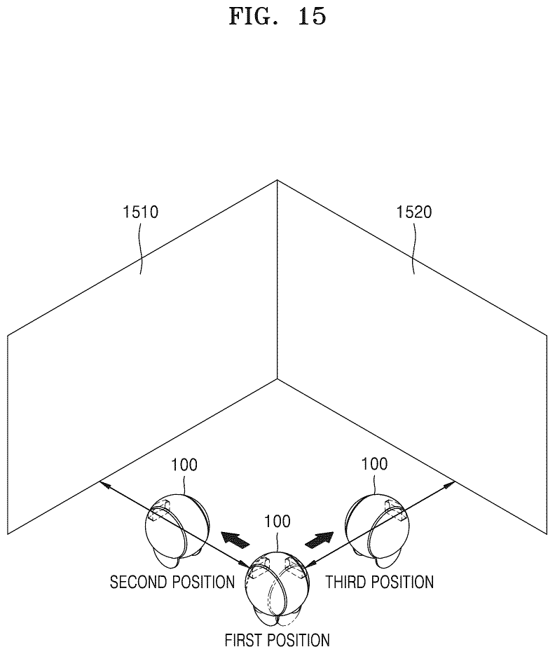

FIG. 15 is a diagram illustrating an operation, performed by a projection device, of moving the projection device or changing a projection lens, according to an embodiment of the disclosure.

Referring to FIG. 15, the projection device 100 according to an embodiment of the disclosure may identify nearby screens. For example, the projection device 100 may determine a first screen 1510 and a second screen 1520 as candidate screens.

The projection device 100 according to an embodiment of the disclosure may be located at a first position, with the projection lens set to the first lens (a short-focal-length lens or an ultra-short-focal-length lens). In addition, the distance between the projection device 100 located at the first position and the first screen 1510, and the distance between the projection device 100 located at the first position and the second screen 1520, may be greater than or equal to a preset distance. Accordingly, the projection device 100 may move to a second position to be closer to the first screen 1510. In some examples, the projection device 100 may move to a third position to be closer to the second screen 1520.

In an embodiment, when the projection device 100 is located at the second position, the distance between the projection device 100 and the second screen 1520 may be greater than the distance between the projection device 100 and the first screen 1510. When the projection device 100 is located at the second position and the projection lens is set to the first lens (a short-focal-length lens or an ultra-short-focal-length lens), the projection device 100 may adjust the projection direction by using the driver, such that the projection direction is toward the first screen 1510. In addition, when the projection device 100 is located at the second position and the projection lens is set to the second lens (a long-focal-length lens), the projection device 100 may adjust the projection direction by using the driver, such that the projection direction is toward the second screen 1520.

In an embodiment, when the projection device 100 is located at the third position, the distance between the projection device 100 and the first screen 1510 may be greater than the distance between the projection device 100 and the second screen 1520. When the projection device 100 is located at the third position and the projection lens is set to the first lens, the projection device 100 may adjust the projection direction by using the driver, such that the projection direction is toward the second screen 1520. In addition, when the projection device 100 is located at the third position and the projection lens is set to the second lens, the projection device 100 may adjust the projection direction by using the driver, such that the projection direction is toward the first screen 1510.

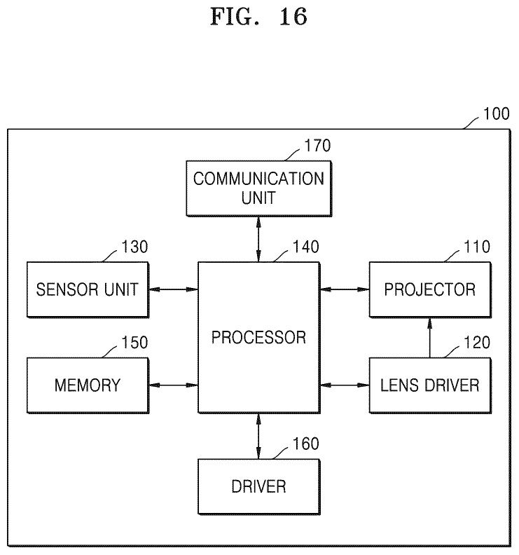

FIG. 16 is a block diagram illustrating a configuration of a projection device, according to an embodiment of the disclosure.

Referring to FIG. 16, the projection device 100 according to an embodiment of the disclosure may include a sensor unit 130, a projector 110, a processor 140, a memory 150, a lens driver 120, a driver 160, and a communication unit 170.

The sensor unit 130 according to an embodiment of the disclosure may sense a state of the surroundings of the projection device 100. The sensor unit 130 may include one or more of a distance sensor, an image sensor, a depth sensor, an infrared sensor, or the like. However, the disclosure is not limited thereto.

The distance sensor according to an embodiment of the disclosure may detect a distance to a nearby object. For example, the distance sensor may include an ultrasonic distance sensor configured to measure a distance by using ultrasonic waves, an infrared distance sensor configured to measure a distance by using infrared rays, a laser distance sensor configured to measure a distance by using a laser, or the like. However, the disclosure is not limited thereto.

The image sensor according to an embodiment of the disclosure may obtain image frames such as still images or moving images. For example, the image sensor may capture an image of the outside of the projection device 100. Here, the image captured by the image sensor may be processed by the processor 140 or a separate image processor.

The depth sensor according to an embodiment of the disclosure may obtain depth information about one or more objects included in a space. The depth information may correspond to a distance from the depth sensor to a particular object, and the depth value may increase as the distance from the depth sensor to the object increases. The depth sensor according to an embodiment of the disclosure may obtain depth information about an object in various ways, for example, by using at least one of a time-of-flight (TOF) method, a stereo image method, or a structured light method.

The depth sensor according to an embodiment of the disclosure may include at least one camera and may obtain depth information about a real space included in the field of view (FOV) of the camera included in the depth sensor.

The sensor unit 130 may include one or more of an acceleration sensor, a position sensor, a temperature/humidity sensor, an illuminance sensor, a geomagnetic sensor, a gyroscope sensor, a microphone, or the like, in addition to the one or more of the distance sensor, the image sensor, the depth sensor, or the infrared sensor. However, the disclosure is not limited thereto.

The sensor unit 130 may transmit the sensed information to the processor 140. The processor 140 may obtain information about the surrounding environment based on the sensed information. The information about the surrounding environment may include at least one of the size, position, or type of a screen located around the projection device 100, the type, size, or position of an object located around the projection device 100, or information about a movement of an object. However, the disclosure is not limited thereto.

The projector 110 according to an embodiment of the disclosure may include a light source that generates light, a lens, and the like. For example, the projector 110 may include a first lens having a first focal length, and a second lens having a second focal length that is greater than the first focal length. The first lens may include at least one of a short-focal-length lens or an ultra-short-focal-length lens. The second lens may include a long-focal-length lens. Accordingly, when projecting media content such as a movie or a television (TV) broadcast program onto a distant screen, the processor 140 may control the projector 110 to project the media content by using the second lens. In addition, when projecting image content that provides a message or information (e.g., a route guidance image or a welcome mode image), the processor 140 may control the projector 110 to project the image content by using the first lens. However, the disclosure is not limited thereto.

The lens driver 120 according to an embodiment of the disclosure may change the projection lens by adjusting the positions of lenses included in the projector 110. For example, the lens driver 120 may include a sliding-type structure, and the first lens and the second lens may be mounted on one side of the sliding-type structure. The lens driver 120 may include a motor, a rail, or the like, and may move the sliding-type structure by using the motor, the rail, or the like. However, the disclosure is not limited thereto.

The lens driver 120 may change the projection lens from the first lens to the second lens, or from the second lens to the first lens.

In addition, the projector 110 according to an embodiment of the disclosure may project various pieces of image content, such as a movie, a TV program, a video, a moving image, an online streaming service or advertisement content. However, the disclosure is not limited thereto.

The driver 160 according to an embodiment of the disclosure may perform movement of the projection device 100 under control of the processor 140. For example, the driver 160 may perform traveling of the projection device 100 or rotational movement of the projector 110 according to a control signal received from the processor 140.

The processor 140 according to an embodiment of the disclosure controls the overall operation of the projection device 100 and a signal flow between internal components of the projection device 100, and performs data processing functions.

The processor 140 may include a single core, dual cores, triple cores, quad cores, or cores corresponding to a multiple thereof. In addition, the processor 140 may include a plurality of processors. For example, the processor 140 may include as a main processor and a sub-processor.

In addition, the processor 140 may include at least one of a central processing unit (CPU), a graphics processing unit (GPU), or a video processing unit (VPU). According to an embodiment of the disclosure, the processor 140 may be implemented as a system on a chip (SoC) into which at least one of a CPU, a GPU, or a VPU is integrated. According to an embodiment of the disclosure, the processor 140 may further include a neural processing unit (NPU).

The memory 150 according to an embodiment of the disclosure may store various pieces of data, programs, or applications for driving and controlling the projection device 100.

In addition, the program stored in memory 150 may include one or more instructions. The program (one or more instructions) or application stored in the memory 150 may be executed by the processor 140.

The processor 140 according to an embodiment of the disclosure may execute one or more instructions stored in the memory 150 to obtain image content to be projected. According to an embodiment of the disclosure, the image content may be image content previously stored in the memory 150 or image content received from an external device through the communication unit 170. In addition, the image content may be an image on which various image processing operations, such as decoding, scaling, noise filtering, frame rate conversion, or resolution conversion, have been performed by a video processing unit.

The processor 140 according to an embodiment of the disclosure may execute one or more instructions stored in the memory 150 to identify a position at which the image content is to be projected.

The processor 140 according to an embodiment of the disclosure may obtain information about the surrounding environment of the projection device 100 and, based on the information about the surrounding environment, determine the position at which the image content is to be projected. For example, the processor 140 may execute one or more instructions stored in the memory 150 to obtain information about the surrounding environment. The information about the surrounding environment may include at least one of the size, position, or type of a screen located around the projection device 100, the type, size, or position of an object located around the projection device 100, or information about a movement of an object. The processor 140 may identify screens located around the projection device 100.

In addition, the processor 140 may execute one or more instructions stored in the memory 150 to determine, based on information about the image content to be projected, the position at which the image content is to be projected.

For example, when the image content to be projected is a media image (e.g., a movie), the processor 140 may identify whether a screen having a size greater than or equal to a preset value exists around the projection device 100, in order to project the media image. When a screen having a size greater than or equal to the preset value is identified around the projection device 100, the processor 140 may determine the position of the screen as the position at which the movie is to be projected.

When the image content to be projected is an image that provides a message or information, the processor 140 may determine a nearby floor or wall as the position at which the image content is to be projected.

According to an embodiment of the disclosure, the processor 140 may determine the projection position based on a user input for selecting any one of the screens identified around the projection device 100 as the projection area.

The processor 140 according to an embodiment of the disclosure may execute one or more instructions stored in the memory 150 to obtain user information and identify a projection position for the image content based on the user information. The user information may include at least one of the user's position, the user's posture, information about the user's life pattern, information about a usage history of the projection device, or the user's age or gender. However, the disclosure is not limited thereto.

For example, the processor 140 may analyze the user's position, state, posture, motion, and the like, based on an image obtained by photographing the user. The processor 140 may predict a behavior of the user based on the state of the user (e.g., a state in which the user is sitting on a sofa and looking at a screen). For example, the processor 140 may predict that the user will request projection of image content onto a screen. The processor 140 may determine the projection position for the image content based on the predicted behavior of the user.

According to an embodiment of the disclosure, the processor 140 may identify the gaze direction of the user based on the posture of the user, and determine an area corresponding to the gaze direction of the user, as the projection position for the image content.

According to an embodiment of the disclosure, the processor 140 may predict a behavior of the user based on the information about a life pattern of the user. For example, the processor 140 may obtain information about a life pattern of the user based on a history of use of the projection device by the user (an hourly usage history). According to an embodiment of the disclosure, the processor 140 may obtain information about a life pattern of the user based on information received from a wearable device worn by the user or a portable terminal carried by the user.

For example, the processor 140 may obtain, based on the information about the life pattern of the user, information that the user performs a first behavior at a first time and performs a second behavior at a second time. The processor 140 may determine the projection position for the image content based on the predicted behavior of the user.

However, the disclosure is not limited thereto, and the processor 140 according to an embodiment of the disclosure may identify a position at which image content is to be projected, in various ways.

The processor 140 according to an embodiment of the disclosure may identify whether to change the projection lens to project the image content to the identified projection position.

The processor 140 may identify whether to change the projection lens, based on the projection lens identified to project the image content to the identified projection position. For example, when the currently set projection lens is the first lens (a short-focal-length lens or an ultra-short-focal-length lens), and the identified projection position is spaced a preset distance or more from the projection device 100, the processor 140 may identify that a change of the projection lens is to be performed, because the second lens (a long-focal-length lens) is identified to project the image content to the projection position. According to an embodiment of the disclosure, when the currently set projection lens is the second lens, and the identified projection position is close to the projection device 100, the processor 140 may identify that a change of the projection lens is to be performed because the first lens is identified to project the image content to the projection position.

In addition, the processor 140 according to an embodiment of the disclosure may identify whether to move the projection device 100 to project the image content to the identified projection position. For example, in order to project the image content to the projection position, the processor 140 may perform a traveling movement to change the position of the projection device 100, or a rotational movement to change the projection direction without changing the position of the projection device 100.

According to an embodiment of the disclosure, when both a change of the projection lens and a movement of the projection device 100 are to be performed, the processor 140 may change the projection lens while moving the projection device 100. For example, the processor 140 may control the lens driver 120 to change the projection lens from the first lens to the second lens, or from the second lens to the first lens, while moving the projection device 100.

Accordingly, by performing the lens change operation while the projection device 100 is moving, waiting time due to the lens change operation may be saved.

According to an embodiment of the disclosure, when the projection device 100 is projecting the image content, the processor 140 may control the projector 110 to pause the playback of the image content and stop the projection during the change of the projection lens and the movement of the projection device.

According to an embodiment of the disclosure, when the image content being played back is advertisement content, the processor 140 may control the projector 110 to continuously play back the advertisement content without pausing it and to stop only the projection, even during the change of the projection lens and the movement of the projection device.

According to an embodiment of the disclosure, in a case in which the projection device 100 includes a cover or the like capable of opening and closing the projector 110, the processor 140 may control the cover to be closed during the change of the projection lens and the movement of the projection device, so as to prevent the image content from being projected onto the screen.

In addition, the processor 140 according to an embodiment of the disclosure may perform control to notify the user that the change of the projection lens and the movement of the projection device are in progress, through an LED module, an audio output module, or the like included in the projection device 100.

The communication unit 170 according to an embodiment of the disclosure may transmit and receive data or signals to and from an external device or a server. For example, the communication unit 170 may include a Wi-Fi module, a Bluetooth module, an infrared communication module and a wireless communication module, a local area network (LAN) module, an Ethernet module, a wired communication module, and the like. Here, each communication module may be implemented as at least one hardware chip.

The Wi-Fi module and the Bluetooth module perform communication by using a Wi-Fi scheme and a Bluetooth scheme, respectively. When the Wi-Fi module or the Bluetooth module is used, various pieces of connection information, such as a service set identifier (SSID) or a session key, may be first transmitted and received, and various pieces of information may be then transmitted and received after a communication connection is established by using the connection information. The wireless communication module may include at least one communication chip configured to perform communication according to various wireless communication standards, such as Zigbee, 3^{rd} Generation (3G), 3^{rd} Generation Partnership Project (3GPP), Long-Term Evolution (LTE), LTE Advanced (LTE-A), 4^{th} Generation (4G), 5^{th} Generation (5G), or the like.

The communication unit 170 according to an embodiment of the disclosure may receive, from an external device, an image or image content to be projected.

The communication unit 170 according to an embodiment of the disclosure may receive user information from a user terminal or a wearable device worn by the user.

The block diagram of the projection device 100 illustrated in FIG. 16 is a block diagram for an embodiment of the disclosure. Each of the components illustrated in the block diagrams may be integrated, added, or omitted according to the specification of the projection device 100 actually implemented. That is, two or more components may be integrated into one component, or one component may be divided into two or more components, as necessary. In addition, a function performed by each block is for describing embodiments of the disclosure, and its detailed operation or device does not limit the scope of the disclosure.

According to an embodiment of the disclosure, a movable projection device may include a projector that includes a first lens having a first focal length, and a second lens having a second focal length greater than the first focal length, and is configured to project image content by using any one of the first lens and the second lens.

According to an embodiment of the disclosure, the projection device may include a lens driver configured to change a projection lens such that the image content is projected through any one of the first lens and the second lens.

According to an embodiment of the disclosure, the projection device may include a memory storing one or more instructions, and at least one processor configured to execute the one or more instructions.

According to an embodiment of the disclosure, the at least one processor may execute the one or more instructions to identify a position at which the image content is to be projected.

According to an embodiment of the disclosure, the at least one processor may execute the one or more instructions to identify, based on the position at which the image content is to be projected, whether a movement of the projection device is to be performed and whether a change of the projection lens is to be performed.

According to an embodiment of the disclosure, the at least one processor may execute the one or more instructions to control, based on identifying to move the projection device and to change the projection lens, the lens driver to change the projection lens from the first lens to the second lens, or from the second lens to the first lens, while moving the projection device.

According to an embodiment of the disclosure, the first lens may include at least one of a short-focal-length lens or an ultra-short-focal-length lens.

According to an embodiment of the disclosure, the second lens may include a long-focal-length lens.

According to an embodiment of the disclosure, the movement of the projection device may include a traveling movement of the projection device and a rotational movement of the projector.

According to an embodiment of the disclosure, the projection device may further include a driver configured to perform the traveling movement of the projection device and the rotational movement of the projector.

According to an embodiment of the disclosure, the at least one processor may execute the one or more instructions to identify whether to change the projection lens, based on information about the projection lens currently set, and information about a lens for projecting the image content to the position at which the image content is to be projected.

According to an embodiment of the disclosure, the at least one processor may execute the one or more instructions to, while moving the projection device, pause playback of the image content and control the projector not to project the image content.

According to an embodiment of the disclosure, the projection device may further include a sensor unit configured to obtain information about a surrounding environment of the projection device.

According to an embodiment of the disclosure, the at least one processor may execute the one or more instructions to identify the position at which the image content is to be projected, based on the information about the surrounding environment of the projection device.

According to an embodiment of the disclosure, the information about the surrounding environment may include at least one of a position, a size, and a type of a screen located around the projection device, or a type, a size, a position, and movement information of an object located around the projection device.

According to an embodiment of the disclosure, the at least one processor may execute the one or more instructions to obtain user information.

According to an embodiment of the disclosure, the at least one processor may execute the one or more instructions to identify, based on the user information, the position at which the image content is to be projected.

According to an embodiment of the disclosure, the user information may include at least one of position information about a user, posture information about the user, life pattern information about the user, or information about a history of use of the projection device by the user.

According to an embodiment of the disclosure, the at least one processor may execute the one or more instructions to identify a gaze direction of the user based on the posture information about the user.

According to an embodiment of the disclosure, the at least one processor may execute the one or more instructions to identify whether to move the projection device and whether to change of the projection lens, to project the image content onto an area toward which the gaze direction of the user is directed.

According to an embodiment of the disclosure, a method of operating a movable projection device may include identifying a position at which image content is to be projected.

According to an embodiment of the disclosure, the method of operating a movable projection device may include identifying, based on the position at which the image content is to be projected, whether to move the projection device and whether to change a projection lens.

According to an embodiment of the disclosure, the method of operating a movable projection device may include, based on identifying to move the projection device and to change the projection lens, changing the projection lens from a first lens having a first focal length to a second lens having a second focal length greater than the first focal length, or from the second lens to the first lens, while moving the projection device.

According to an embodiment of the disclosure, the method of operating a movable projection device may include projecting the image content.

According to an embodiment of the disclosure, the first lens may include at least one of a short-focal-length lens or an ultra-short-focal-length lens.

According to an embodiment of the disclosure, the second lens may include a long-focal-length lens.

According to an embodiment of the disclosure, the changing of the projection lens while moving the projection device may include changing the projection lens while performing a traveling movement of the projection device or while performing a rotational movement of a projector.

According to an embodiment of the disclosure, the identifying whether to change the projection lens may include identifying whether to change the projection lens, based on information about the projection lens currently set, and information about a lens for projecting the image content to the position at which the image content is to be projected.

According to an embodiment of the disclosure, the changing of the projection lens while moving the projection device may include, while moving the projection device, pausing playback of the image content and controlling the projector not to project the image content.

According to an embodiment of the disclosure, the method of operating a movable projection device may further include obtaining information about a surrounding environment of the projection device.

According to an embodiment of the disclosure, the identifying of the position at which the image content is to be projected may include identifying the position at which the image content is to be projected, based on the information about the surrounding environment of the projection device.

According to an embodiment of the disclosure, the information about the surrounding environment may include at least one of a position, a size, and a type of a screen located around the projection device, or a type, a size, a position, and movement information of an object located around the projection device.

According to an embodiment of the disclosure, the method of operating a movable projection device may further include obtaining user information.

According to an embodiment of the disclosure, the identifying of the position at which the image content is to be projected may include identifying, based on the user information, the position at which the image content is to be projected.

According to an embodiment of the disclosure, the user information may include at least one of position information about a user, posture information about the user, life pattern information about the user, or information about a history of use of the projection device by the user.

According to an embodiment of the disclosure, when both a movement of the projection device and a change of the projection lens are to be performed, the projection device may change the projection lens while the projection device is moving so as to save the time required for changing the lens.

According to an embodiment of the disclosure, by changing in advance the position and the projection lens state of the projection device based on a predicted behavior of the user, the projection device may perform projection immediately when a user request is received, without waiting time.

The projection device according to an embodiment of the disclosure may project image content according to the gaze direction of the user by moving the projection device or changing the projection lens based on the user's posture, even without a separate request from the user, thereby improving the user convenience.

According to an embodiment of the disclosure, by changing in advance the position and the projection lens state of the projection device based on a life pattern of the user, the projection device may perform projection immediately when a user request is received, without waiting time.

The method of operating a projection device according to an embodiment of the disclosure may be embodied as program commands executable by various computer devices, and recorded on a computer-readable medium. The computer-readable medium may include program commands, data files, data structures, or the like separately or in combinations. The program commands to be recorded on the medium may be specially designed and configured for the disclosure or may be well-known to and be usable by those skill in the art of computer software. Examples of the computer-readable recording medium include magnetic media such as hard disks, floppy disks, or magnetic tapes, optical media such as a compact disc read-only memory (CD-ROM) or a digital video disc (DVD), magneto-optical media such as a floptical disk, and hardware devices such as read-only memory (ROM), random-access memory (RAM), or flash memory, which are specially configured to store and execute program commands. Examples of program commands include not only machine code, such as code made by a compiler, but also high-level language code that is executable by a computer by using an interpreter or the like.

In addition, the method of operating a projection device according to embodiments of the disclosure may be provided in a computer program product. The computer program product may be traded as commodities between sellers and buyers.

The computer program product may include a software (S/W) program and a computer-readable recording medium storing the S/W program. For example, the computer program product may include a product in the form of a S/W program electronically distributed (e.g., a downloadable application) through a manufacturer of an electronic device or an electronic market (e.g., Google Play Store, App Store). For electronic distribution, at least part of the S/W program may be stored in a storage medium or temporarily generated. In this case, the storage medium may be a storage medium of a server of the manufacturer or a server of the electronic market, or a relay server that temporarily stores the S/W program.

The computer program product may include a storage medium of a server or a storage medium of a client device, in a system consisting of the server and the client device. Alternatively, when there is a third device (e.g., a smart phone) communicatively connected to the server or the client device, the computer program product may include a storage medium of the third device. Alternatively, the computer program product may include a software program, which is transmitted from the server to the client device or the third device or transmitted from the third device to the client device.

In this case, any one of the server, the client device, and the third device may execute the computer program product to perform the method according to the embodiments of the disclosure. Alternatively, two or more of the server, the client device, and the third device may execute the computer program product to execute the method according to the disclosed embodiments in a distributed manner.

For example, the server (e.g., a cloud server, an artificial intelligence server) may execute the computer program product stored in the server to control the client device communicatively connected to the server to perform the method according to the disclosed embodiments of the disclosure.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A movable projection device comprising:
a projector comprising a first lens having a first focal length, and a second lens having a second focal length that is greater than the first focal length, wherein the projector is configured to project image content through a projection lens that is one of the first lens or the second lens;
a lens driver configured to change the projection lens through which the image content is projected;
a memory storing one or more instructions; and
at least one processor configured to execute the one or more instructions to:
identify a position at which the image content is to be projected,
based on the position at which the image content is to be projected, identify whether to move the movable projection device and whether to change the projection lens, and
based on identifying to move the movable projection device and to change the projection lens, control the lens driver to change the projection lens from the one of the first lens or the second lens to another of the first lens or the second lens, in a moving state of the movable projection device.

2. The movable projection device of claim 1, wherein the first lens further comprises at least one of a short-focal-length lens or an ultra-short-focal-length lens, and
wherein the second lens further comprises a long-focal-length lens.

3. The movable projection device of claim 1, further comprising a driver configured to perform a traveling movement of the movable projection device and perform a rotational movement of the projector,
wherein the at least one processor is further configured to execute the one or more instructions to, in the moving state of the movable projection device, control the driver to perform the traveling movement of the movable projection device or to perform the rotational movement of the projector.

4. The movable projection device of claim 1, wherein the at least one processor is further configured to execute the one or more instructions to identify whether to change the projection lens, based on information about the projection lens and information about a lens corresponding to the position at which the image content is to be projected.

5. The movable projection device of claim 1, wherein the at least one processor is further configured to execute the one or more instructions to, in the moving state of the movable projection device, pause the image content and control the projector to not project the image content.

6. The movable projection device of claim 1, further comprising a sensor configured to obtain information about a surrounding environment of the movable projection device,
wherein the at least one processor is further configured to execute the one or more instructions to identify the position at which the image content is to be projected, based on the information about the surrounding environment of the movable projection device.

7. The movable projection device of claim 6, wherein the information about the surrounding environment comprises at least one of a position, a size, and a type of a screen, or a type, a size, a position, and movement information of an object.

8. The movable projection device of claim 1, wherein the at least one processor is further configured to execute the one or more instructions to:
obtain user information, and
based on the user information, identify the position at which the image content is to be projected.

9. The movable projection device of claim 8, wherein the user information comprises at least one of position information about a user, posture information about the user, lifestyle pattern information about the user, or information about a history of using the movable projection device by the user.

10. The movable projection device of claim 9, wherein the at least one processor is further configured to execute the one or more instructions to:
identify a gaze direction of the user based on the posture information about the user,
identify the position at which the image content is to be projected according to the gaze direction of the user, and
identify whether to move the movable projection device and whether to change the projection lens, based on the position at which the image content is to be projected according to the gaze direction of the user.

11. A method of operating a movable projection device comprising a projector including a first lens having a first focal length and a second lens having a second focal length greater than the first focal length, and a lens driver configured to change a projection lens through which image content is projected, the method comprising:
identifying a position at which the image content is to be projected;
based on the position at which the image content is to be projected, identifying whether to move the movable projection device and whether to change the projection lens;
based on identifying to move the movable projection device and to change the projection lens, changing the projection lens from one of the first lens or the second lens to another of the first lens or the second lens, in a moving state of the movable projection device; and
projecting the image content.

12. The method of claim 11, wherein the first lens comprises at least one of a short-focal-length lens or an ultra-short-focal-length lens, and
wherein the second lens comprises a long-focal-length lens.

13. The method of claim 11, wherein the movable projection device further comprises a driver configured to perform a traveling movement of the movable projection device and perform a rotational movement of the projector, and
wherein the changing the projection lens in the moving state comprises:
changing the projection lens in a state of controlling the driver to perform the traveling movement of the movable projection device or in a state of controlling the driver to perform the rotational movement of the projector.

14. The method of claim 11, wherein the identifying whether to change the projection lens is based on information about the projection lens, and information about a lens corresponding to the position at which the image content is to be projected.

15. The method of claim 11, further comprising, in the moving state of the movable projection device, pausing the image content and controlling the projector to not project the image content.

16. The method of claim 11, further comprising obtaining information about a surrounding environment of the movable projection device,
wherein the identifying the position at which the image content is to be projected comprises identifying the position at which the image content is to be projected, based on the information about the surrounding environment of the movable projection device.

17. The method of claim 16, wherein the information about the surrounding environment comprises at least one of a position, a size, and a type of a screen, or a type, a size, a position, and movement information of an object.

18. The method of claim 11, further comprising obtaining user information,
wherein the identifying the position at which the image content is to be projected comprises identifying, based on the user information, the position at which the image content is to be projected.

19. The method of claim 18, wherein the user information comprises at least one of position information about a user, posture information about the user, lifestyle pattern information about the user, or information about a history of using the movable projection device by the user.

20. A non-transitory computer-readable recording medium having stored therein a program that, when executed, causes one or more processors to execute a method comprising:
identifying a position at which image content is to be projected;
based on the position at which the image content is to be projected, identifying whether to move a movable projection device and identifying whether to change a projection lens through which the image content is projected;
based on identifying to move the movable projection device and identifying to change the projection lens, changing the projection lens from one of a first lens or a second lens to another of the first lens or the second lens, in a moving state of the movable projection device; and
projecting the image content.
